(19) United States
(12) Patent Application Publication
(10) Pub. No.: US 2009/0027346 A1
(43) Pub. Date: Jan. 29, 2009

(54) METHODS AND SYSTEMS FOR PERSONALIZING AND BRANDING MOBILE DEVICE KEYPADS

(76) Inventors: Aditya Narain SRIVASTAVA, Fremont, CA (US); Alhad Shrikant PURNAPATRE, San Diego, CA (US)

Correspondence Address: QUALCOMM INCORPORATED, 5775 MOREHOUSE DR., SAN DIEGO, CA, 92121, US

(21) Appl. No.: 12/139,868

(22) Filed: Jun. 16, 2008

Related U.S. Application Data
(60) Provisional application No. 60/950,112, filed on Jul. 16, 2007.

(51) Int. Cl. G06F 3/02; G06F 3/041; H04M 1/00

(52) U.S. Cl. 345/169; 345/173; 455/550.1

(57) ABSTRACT

Methods and systems for configuring keypads are provided to enable configuring display keypads to display themes, vary display fonts or present other graphics. An application may provide instructions to a keypad protocol to change the theme of or the size of the letters and numbers on the keypad. Alternatively, a keypad protocol can enable users to configure keypad displays. In an application the keypad can be configured to display advertising. Keys configured for advertising can allow users to receive advertisement content on their computing devices.

### RELATED APPLICATIONS

The present application claims the benefit of priority to U.S. Provisional Patent Application No. 60/950,112 filed Jul. 16, 2007 entitled “Dynamically Configurable Keypad,” the entire contents of which are hereby incorporated by reference.

### FIELD OF THE INVENTION

The present invention relates generally to mobile computer systems, and more particularly to personalizing and branding the layout and functionality of keypads on mobile devices.

### BACKGROUND

The usage of mobile electronic devices (mobile devices), such as cellular telephones, is ever increasing due to their portability, connectivity and ever increasing computing power. As mobile devices grow in sophistication, the variety and sophistication of application software is increasing, turning mobile devices into multipurpose productivity tools. Yet, the usefulness of mobile devices and their applications are limited by the small area available for the user-interface. Traditional cellular telephones included a simple keypad of fixed configuration. Recently, mobile devices have been released featuring miniature QWERTY keyboards, touchscreen interfaces, and reconfigurable keys. Further keypad innovations are expected to provide better user-interfaces and support more useful applications.

### SUMMARY

Various embodiment methods and systems enable personalized branded configurations for keypad layouts, graphics and functionality on mobile devices. Keypad appearance and functionality may be determined by a theme active on the mobile device. New key and new key functionality may be provided based upon the application running on the mobile device or to provide user access to services and data. Customizable virtual keypads may be configured with pictures and other graphics to identify speed dial and other key assignments. Application software running on the computing device may determine the key layout and functionality to match the functionality of the keypad. The layout, appearance and functionality of the keypad may be managed by a keypad protocol operating as part of the system software.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention.

FIG. 1 is a component block diagram of a typical cell phone usable with the various embodiments.

FIG. 2 is a system component diagram of a cell phone system enabled by the various embodiments.

FIG. 3 is a hardware/software architecture diagram of an embodiment.

FIG. 4 is a message structure diagram of an embodiment.

FIGS. 5 and 6 are a top view and a cross-sectional view, respectively, of a keypad employing display keys.

FIGS. 7 and 8 are illustrations of a cell phone including a touchscreen user-interface.

FIG. 9 is an illustration of a cell phone including displays positioned above keys.

FIG. 10 is a process flow diagram of an embodiment.

FIGS. 11A and 11B are illustrations of an embodiment employing keypad displays presenting a spider theme.

FIGS. 12A and 12B are illustrations of an embodiment employing a touchscreen keypad present without a theme and with a spider theme, respectively.

FIG. 13 is an illustration of an embodiment employing touchscreen keypad presenting a spider theme on virtual keys.

FIGS. 14A and 14B are illustrations of a cell phone including key displays presenting a spider theme.

FIG. 15 is a process flow diagram of an embodiment.

FIGS. 16A and 16B are illustrations of an embodiment employing keypad displays presenting key font size enlargement.

FIGS. 17A and 17B are illustrations of an embodiment employing touchscreen keypad presenting key font size enlargement.

FIGS. 18A and 18B are illustrations of a cell phone including key displays presenting enlargement of key font sizes.

FIG. 19 is a network diagram of an embodiment.

FIG. 20 is a flow diagram of an embodiment.

FIG. 21 is an illustration of an embodiment employing keypad displays presenting a keypad advertisement.

FIGS. 22 and 23 are illustrations of an embodiment employing a touchscreen keypad presenting keypad advertisements.

FIG. 24 is an illustration of a cell phone including key displays presenting a keypad advertisement.

FIGS. 25A and 25B are illustrations of an embodiment employing a touch sensitive keypad presenting a keypad advertisement.

FIG. 26 is a flow diagram of an embodiment.

FIG. 27 is an illustration of an embodiment employing keypad displays presenting a key display identifying a speed-dialing assignment.

FIG. 28 is an illustration of an embodiment employing a touchscreen keypad presenting speed-dialing virtual keys.

FIG. 29 is an illustration of a cell phone including key displays presenting a key display identifying a speed-dial assignment.

FIGS. 30A and 30B are illustrations of an embodiment employing a touch sensitive keypad presenting speed-dialing function.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In this description, the terms “exemplary” is used herein to mean “serving as an example, instance, or illustration.” Any implementation described herein as “exemplary” is not necessarily to be construed as preferred or advantageous over other implementations.

As used herein, the term “computing device” refers to any programmable computer device including a display and a keyboard or keypad. In description of the embodiment, reference is made to “mobile devices” which are but one type of computing device that implement the various embodiments. As used herein, the terms “mobile handsets” and “mobile devices” are used interchangeably and refer to any one of various cellular telephones, personal data assistants (PDA's), palm-top computers, laptop computers with wireless modems, wireless electronic mail receivers (e.g., the Blackberry® and Treo® devices), cellular telephones, and multimedia Internet enabled cellular telephones (e.g., the iPhone®), and similar computing devices.

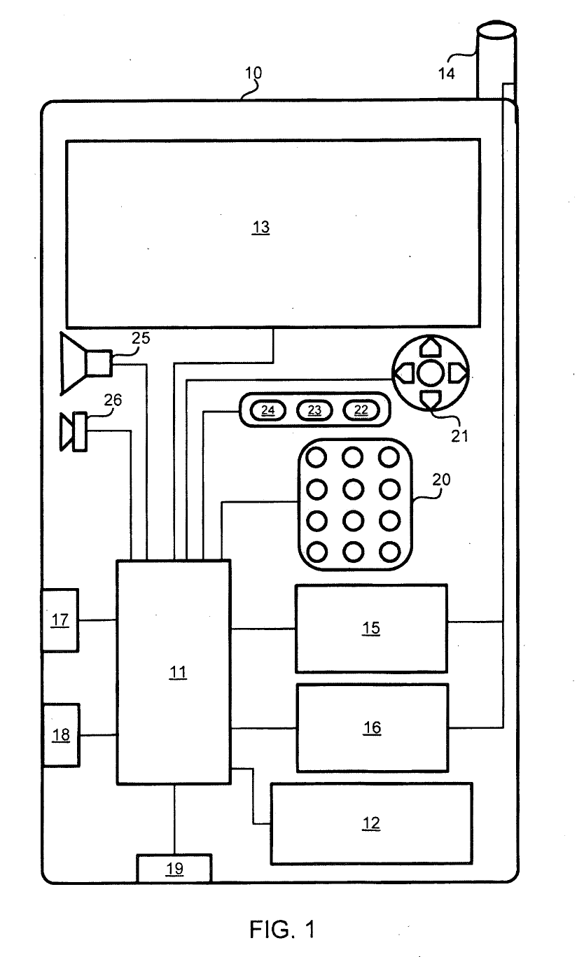

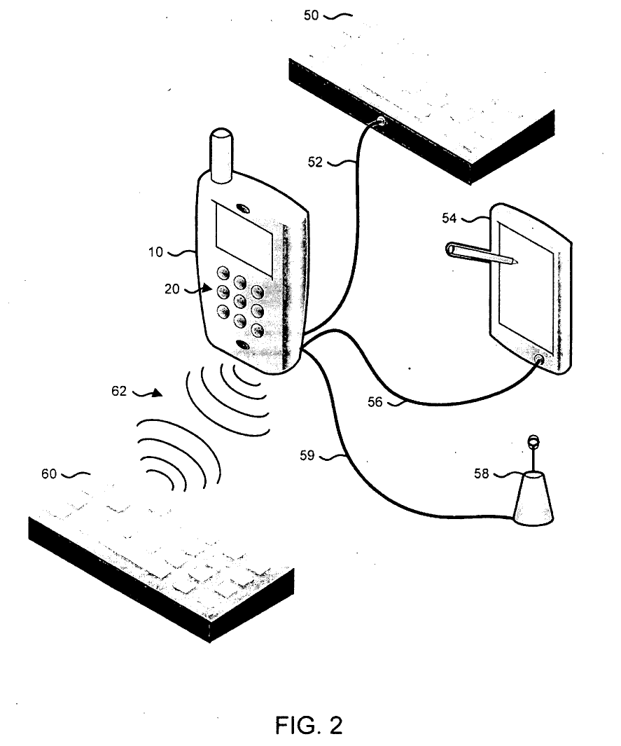

The embodiments described herein may be implemented on any of a variety of mobile devices. Typically, such mobile devices will have in common the components illustrated in FIG. 1. For example, the mobile device 10 may include a processor 11 coupled to internal memory 12 and a display 13. Additionally, the mobile device 10 will have an antenna 14 for sending and receiving electromagnetic radiation that is connected to a wireless data link and/or cellular telephone transceiver 15 coupled to the processor 11. In some implementations, the transceiver 15 and portions of the processor 11 and memory 12 used for cellular telephone communications are collectively referred to as the air interface since it provides a data interface via a wireless data link. Additionally, the mobile device 10 may include a close to medium range transceiver 16, such as a BlueTooth® transceiver for establishing a wireless data link with other components, such as a wireless keypad, described in more detailed below with reference to FIG. 2. Mobile device 10 may also include connector plugs for connecting data cables, such as a FireWire connector 17 and/or USB connector 18, to the processor 11, as well as an infrared data link (e.g., IRDA) transceiver 19 connected to the processor 11 for establishing communication links with external devices such as keyboards, touch screens, as described in more detail below with reference to FIG. 2. Mobile devices 10 also typically include a keypad 20 or miniature keyboard and menu selection buttons or rocker switches 21 for receiving user inputs, and may include application-programmable buttons 22, 23, 24.

As used herein, the term “keypad” refers to any of a variety of user interfaces in which a user presses a button or key in order to communicate to a mobile device that a function associated with the key should be implemented. Examples of keypads encompassed within the following description include the number keypads of conventional cellular telephones, miniature keyboards and is implemented on a variety of mobile devices, external keypads and keyboards which may be electronically coupled to a mobile device (e.g., via a wired or wireless data link), computer keyboards, and musical keyboards which may be coupled to a personal computer, mobile device or other computing device. For ease of description, the figures depict and the descriptions refer to the keypad of a typical cellular telephone. However, these descriptions and illustrations are for example only, and are not intended to limit the scope of the description or the claims to a particular keypad configuration.

Modern cellular telephones and other mobile devices make use of a variety of different keypads for receiving user inputs. New kinds of keypads providing greater flexibility are expected in the future. Additionally, mobile devices 10 can be connected to external user-interfaces, such as keyboards, keypads and game interfaces, as illustrated in FIG. 2. Thus, a mobile device 10 may include a keypad 20, such as described herein or a touchscreen keypad, and also be connected to an external keyboard 50 such as by means of a cable 52, such as a FireWire® or USB cable. A mobile device 10 may also be connected to a touch sensitive display or user-interface, such as a drawing pad 54 by a cable 56. Instead of or in addition to cable connectors, external user input devices, such as a keyboard 60, may be coupled to the mobile device by a wireless data link 62, such as a Bluetooth® wireless data link or an infrared data link (e.g., according to the Infrared Data Association (IrDA) specification). With so many different kinds of user-interfaces available to consumers, application developers face a challenge when writing new application software.

In addition to external keypads, some modern mobile devices include two or more keypads integrated within the device. For example, some cellular telephone designs include a number keypad for use in placing telephone calls, and a miniature keyboard which can be activated by sliding, opening or rotating a portion of the telephone to expose the keyboard. As another example, some cellular telephones may include a fixed keypad and a touchscreen user-interface which may be operated as a passive display or a touch sensitive interface depending upon user selections and application software. Thus, even a mobile device 10 that does not have an external keyboard or interface attached may include a plurality of keypads for interfacing with application software.

Using previously known system/hardware architectures, application developers had to adapt their software to the keypad layout and associated functionality unique to each type of mobile device 10 on which the application might be loaded. Thus, an application configured for a conventional keypad might not function on a mobile device having a touchscreen keypad, and an application written for a touchscreen-equipped mobile device 10 would not operate on a convention mobile device 10. If an application developer wanted to write a single application that could be used on several kinds of devices, the developer had to anticipate and address in software all of the different kinds of keypads that may be used on the various mobile devices. Thus, the application software would have to include code and information needed to interoperate with each type of device keyboard layout and key press event signal. This requirement increased software complexity and made it difficult for application developers to provide affordable applications that could be run on a variety of devices. Also, application developers could not write applications operable on future mobile devices employing keypads not yet to be developed. As a result, application development has necessarily lagged hardware development. Additionally, the different keypad layouts and functionality used on different kinds of devices made it difficult for developers to create applications having a common look and feel across a variety of mobile devices.

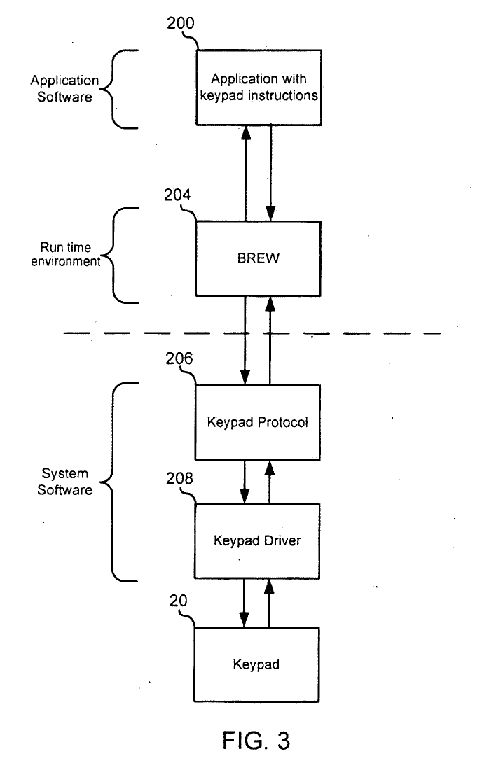

The various embodiments employ a keypad protocol layer within system software that facilitates the embodiment methods and applications. Such a keypad protocol is described in U.S. patent application Ser. No. ______ entitled “Standardized Method and Systems for Interfacing with Configurable Keypads”, which is filed concurrently herewith, the entire contents of which are hereby incorporated by reference. The keypad protocol layer serves as an interface between application software and keypad drivers that enable application software to define keypad configuration requirements to the operating system and receive configuration instructions in standard formats. By doing so, the process of configuring a keypad by for example changing the layout or the functionality of the keys on the keypad can be performed by the keypad protocol, removing the need for this processing from the application software. If a mobile device 10 is equipped with a touch sensitive keypad then this will be known to the keypad protocol layer which can communicate with the mobile device display to present the associated value or function that has been assigned by the application. In this manner, a software application can be written for a variety of mobile devices without having to accommodate the touch sensitive keypad functionality described herein. The following description with reference to FIGS. 3 through 30 describes embodiments which are implemented on mobile devices 10 which include such a keypad protocol layer within their system software.

FIG. 3 illustrates a hardware/software architecture suitable for implementing the various embodiments. As illustrated, the keypad protocol 206 is provided as part of the system software linking to a keypad driver 208 and to run time environment software, such as the Binary run time environment for wireless BREW® layer 204. the keypad driver 208 may be included to provide a software interface with various hardware user-interfaces, such as traditional fixed keypads, external keypads, a touchscreen, a display key keypad (which are described in more detail below) and others. Each type of user-interface may have its own respective hardware driver. Keypad 20 configuration requirements and compatibilities are sent to the keypad protocol 206. The keypad driver 208 translates the information that is sent from the keypad 20 into a format that can be understood by the keypad protocol 206. As discussed above, this format may be standardized so that hardware driver developers have a common interface specification that can be used in developing drivers for all keypads 20.

When an application 200 is started on a mobile device 10, the keypad configuration instructions are sent from the application 200 through runtime environment software 204 to the keypad protocol 206. Alternatively, the application 200 may send configuration instructions directly to the keypad protocol 206. Using these configuration instructions, the keypad protocol 206 configures the keypad 20 such as to change images presented on the keypad 20 to implement a theme on the key or to define the function of a key.

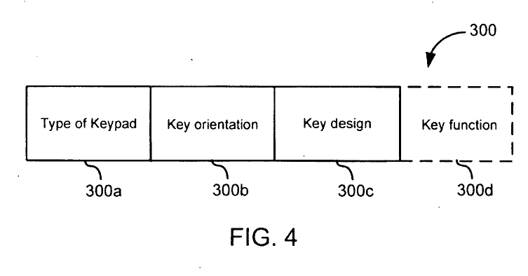

Different applications 200 may require that different keys on a mobile device 10 appear or function in a particular manner defined by the application 200. FIG. 4 illustrates a structure of a configuration instruction message 300 which the application 200 can be send to the keypad protocol 206 when communicating the layout and function of the keypad 20. The configuration instruction message 300 may include information about the type of keypad 300a that is compatible with the application 200 instructions, the key orientation 300b, a key design 300c of each key and/or the key function 300d. This configuration message 300 is received by the keypad protocol 206 and is used to instruct the keypad 20 to configure its layout and/or function as instructed by the application 200.

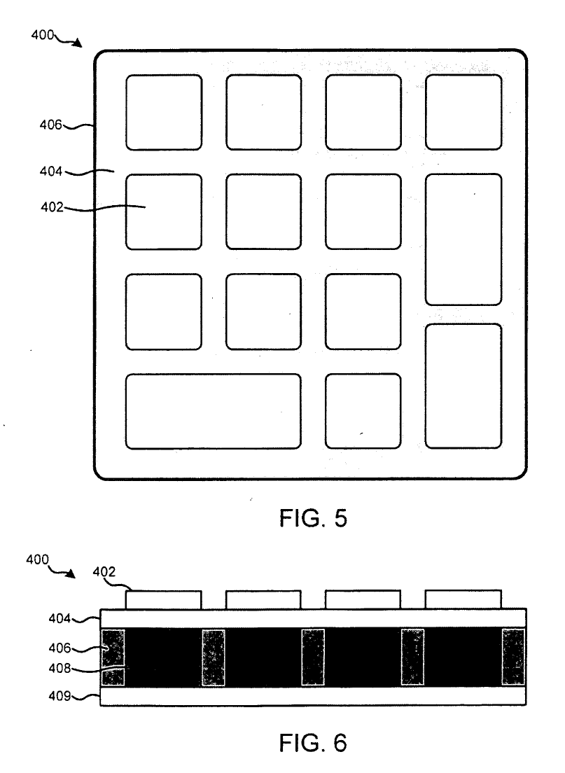

The various embodiments may be implemented on configurable keypad 20 technologies. An example of a configurable keypad 20 technology is illustrated in FIGS. 5 and 6 in which each key has associated with it a small display allowing the key to be labeled dynamically. Such a display-key keypad 400 may include transparent keys 402 positioned within a framework 404 and supported by a support structure 406. A display 408 beneath each transparent key 402 can be controlled by the mobile device processor 11 to present a free-form image viewable through the key 402. A bottom structure 410 may provide support for the displays 408 as well as electrical connections for coupling the displays to the processor 11.

A display-key keypad 400 can provide many advantages to mobile devices since individual key functions can be communicated to users by the images presented on the keys 402 themselves. Thus, words, numbers or symbols can be displayed in the key itself so that its functionality is obvious. In order to enable such a keypad to be easily implemented, applications 200 can define the function associated with each key 402 as well as provide graphics that are presented on each of the key displays 408. This additional complexity can be facilitated by a keypad protocol 206 as described above.

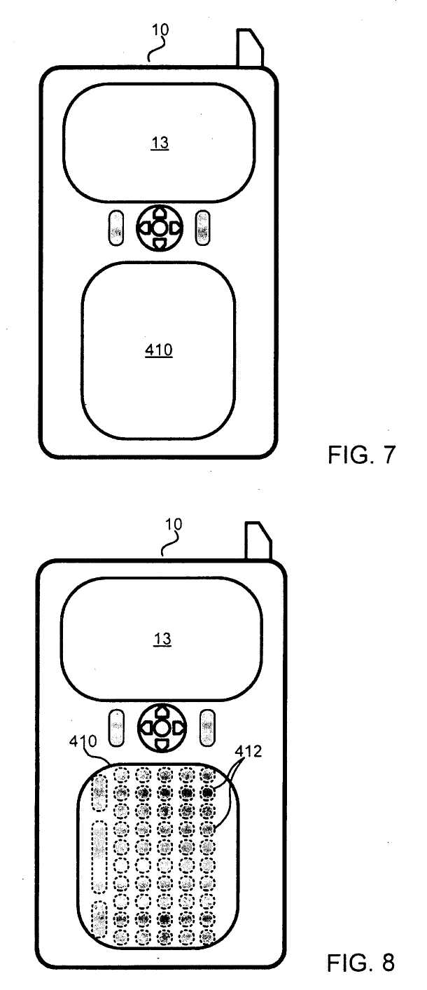

Another form of mobile device keypad/user-interface is a touchscreen, such as illustrated in FIGS. 7 and 8. In such a mobile device 10, a touchscreen 410 provides a completely flexible keypad and user-interface. Keys can be placed anywhere on the touchscreen 410 and identified with graphics to define their function. For example, a miniature keyboard can be presented on the touchscreen display 410 by presenting small virtual buttons 412 with their corresponding meaning identified by a small graphic, such as “A”, “2”, etc. Touchscreen displays provide great flexibility for creating user-interfaces that are completely configurable by applications 200. Without the benefits of the keypad protocol 206, this flexibility will impose additional complexity on application software. The keypad protocol 206 can simplify the development display/keypad configurations for touchscreens. Instead of having to configure specific touchscreens within application software 200, application developers can provide descriptive configuration information and graphic files to the keypad protocol 206 using standard formats and APIs, leaving the complexity of interfacing with the variety of touchscreen designs to the keypad protocol 206.

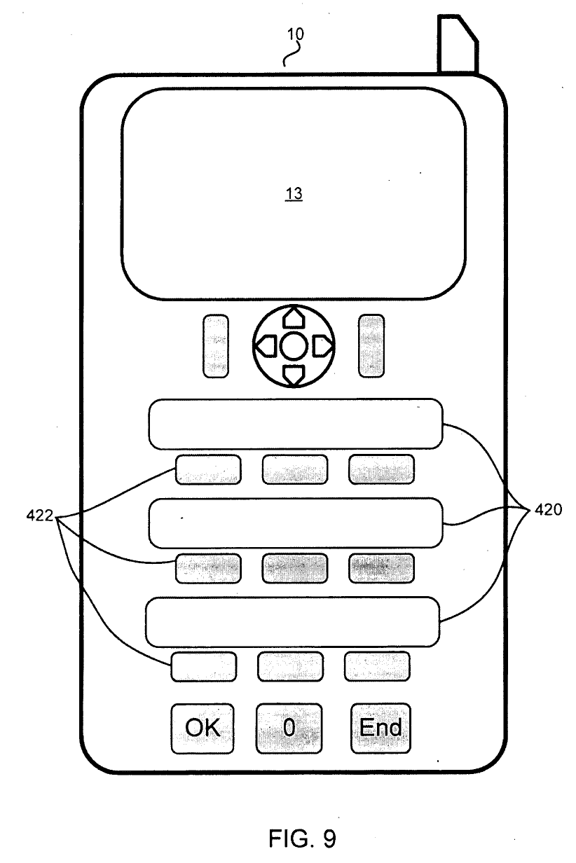

A third form of keypad 20 that may be employed on future mobile devices 10 is illustrated in FIG. 9. In this key keypad configuration, small displays 420 are positioned above, beside or beneath hard keys 422 so that key function definitions can be presented on the small displays. The small displays 420 may be liquid crystal displays similar to the main mobile device display 13. An example of such a keypad display is disclosed in U.S. Pat. No. 6,703,963, the entire contents of which are hereby incorporated by reference. The small displays 420 are coupled to the mobile device processor 11 so that the displays 420 can be controlled via application 200 and system software. This keypad design is highly flexible since it enables key functions to be dynamically assigned with the key functions communicated to users in the form of graphics or alphanumeric characters. As with other display concepts described above with reference to FIGS. 5-7, instead of having to configure the small keypad displays 420 within application software, application developers can provide descriptive configuration information and graphic files to the keypad protocol 206 in standard formats, leaving the complexity of interfacing with the keypad to the keypad protocol 206.

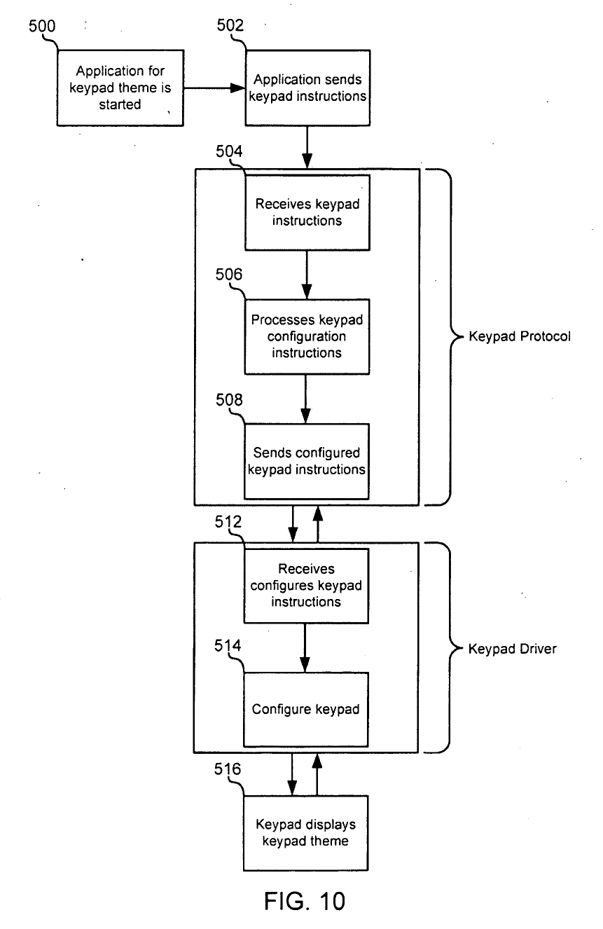

In an embodiment, the mobile device may be configured with software so users may change the theme of their mobile device 10, including the keypad 20. The ability to customize the theme of the keypad 20 to match the theme implemented on the display and the menu improves the user experience since the entire mobile device is themed (not just the display and ring tones). FIG. 10 illustrates example method steps that may be implemented in an embodiment for changing the theme of the keypad 20. The process of applying a theme to the keypad may be implemented using an application 200. Once an application 200 for changing the keypad 20 theme is started, step 500, that application can send a keypad configuration instruction to the keypad protocol 206, step 502. This configuration instruction may include graphics files (or pointers to graphic files stored in memory) to be implemented in applying the theme to the keypad 20. The keypad protocol 206 receives the keypad configuration instruction, step 504, and processes the data, step 506. The keypad protocol 206 then sends the keypad configuration instructions to the keypad driver 208, step 512. The keypad configuration instructions provided to the keypad driver 208 may include the graphics to be displayed on the keypad as wells as key identifiers that the keypad driver 208 can use to inform the keypad protocol 206 when particular keys are pressed. Upon receiving the keypad configuration instructions, step 512, the keypad driver 208 configures the keypad 20, step 514. Thus, the keypad driver may configure the keypad to display images associated with the theme according to the configuration instructions received from the keypad protocol 206, step 516. When keys are then pressed, the keypad 20 reports the key press events to the keypad protocol 206 through the keypad driver 208 consistent with the key configuration (e.g., assigned functionality) defined by the application 200.

While this embodiment is described as being implemented by a theme-change application 200, the ability to set themes may alternatively be included within the functionality of the keypad protocol 206. In this embodiment, the keypad protocol software includes a routine that may be activated by users which presents a menu or other suitable user interface for receiving instructions from users for setting the theme on the mobile device keypad 20. Such a routine may be a separate function, or may be integrated with theme setting functionality of the mobile device operating system software.

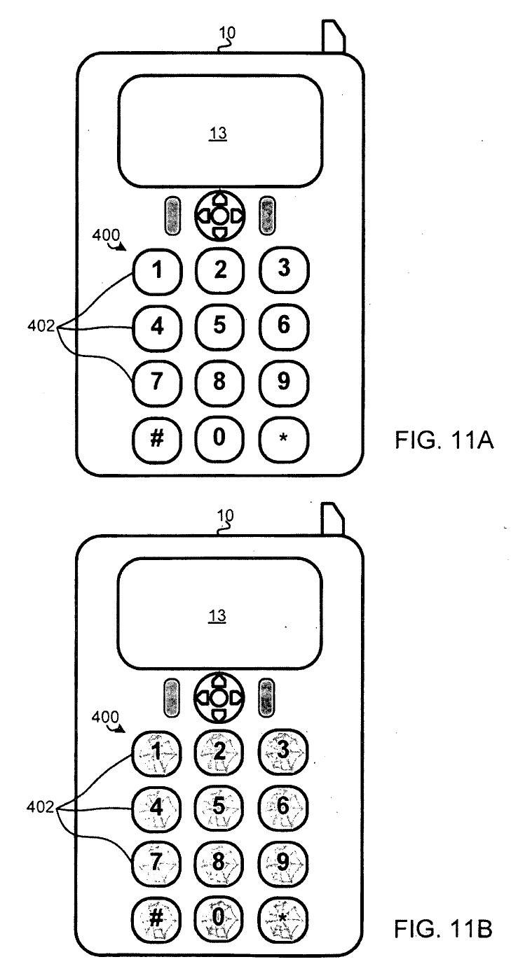

In an example, a mobile device 10 equipped with a display key-keypad 400, as described above with reference to FIGS. 5 and 6, may be configured so the display keys 402 display numbers 0-9 as illustrated in FIG. 11A. Users can easily implement a new theme on the display key keypad 400 using the keypad protocol 206 with the selected theme appearing on the display 13, the cell phone menus and the display keys 402.

For example, as illustrated in FIG. 11B, users who are fans of the Spiderman movies or otherwise enjoy spider themes may customize their mobile devices 10 to show spiders, spider webs or spider related images on the keypad 20 of the mobile device 10. FIG. 11B shows spider webs appear as a background to each display key 402. Other examples of keypad themes include setting the background colors, displaying still theme images, presenting animated images (such as images animated according to theme music or ringtones of the mobile device). As an example, an animated theme could be a dancer on the displayed on the keypad 20 or keys 402 that is animated when a ringtone plays and whose style of dance changes depending on the ringtone chosen by the user.

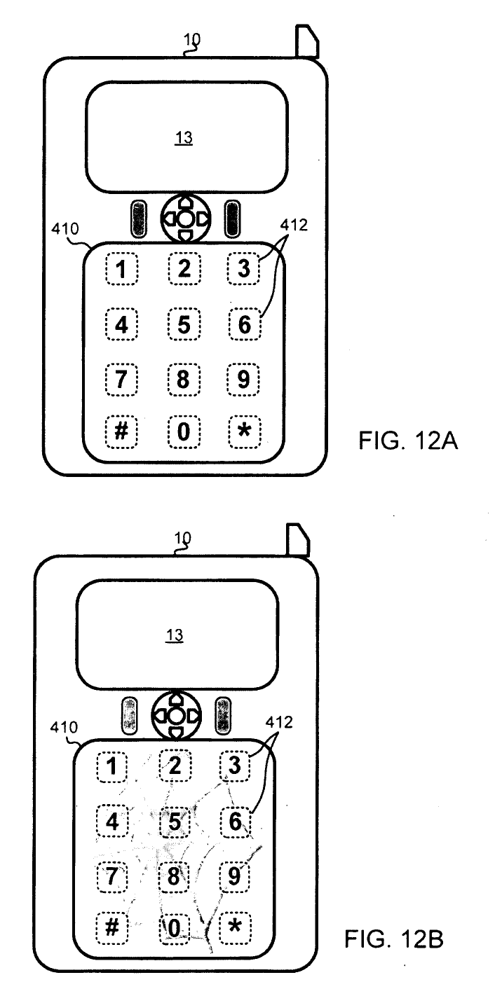

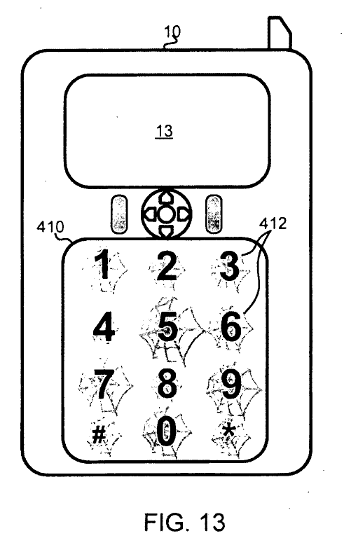

FIG. 12A provides an example of a mobile device 10 equipped with a touchscreen user-interface 410 displaying virtual keys 412 configured as numerals for a cell phone application. An example of the spider theme implemented as the background of the touchscreen user-interface 410 is illustrated in FIG. 12B. Alternatively, users may select to change each virtual key 412 to appear as spider webs, as shown in FIG. 13.

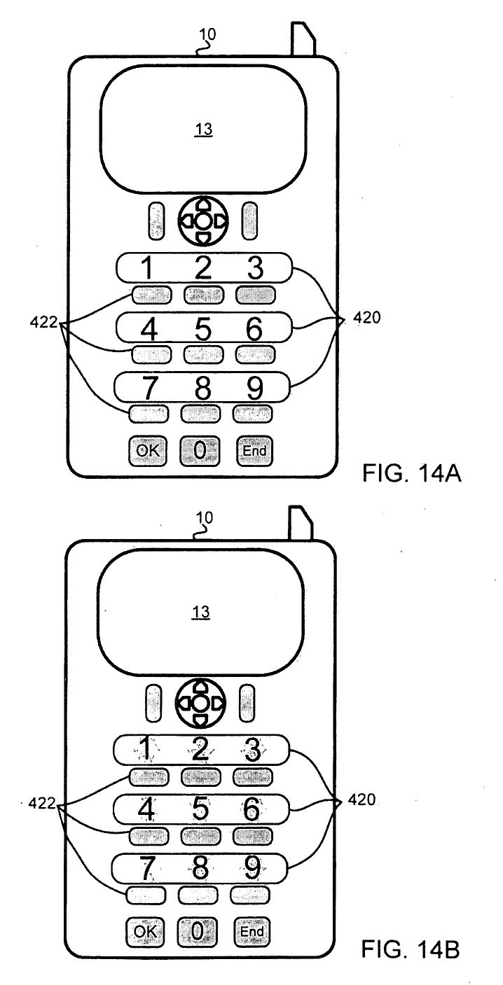

Similarly, a mobile device 10 equipped with keypad display 420 positioned above keys 422 illustrated in FIG. 14A can be configured by user selection to present the spider theme above the keys as background to the numbers in a telephone application as illustrated in FIG. 14B.

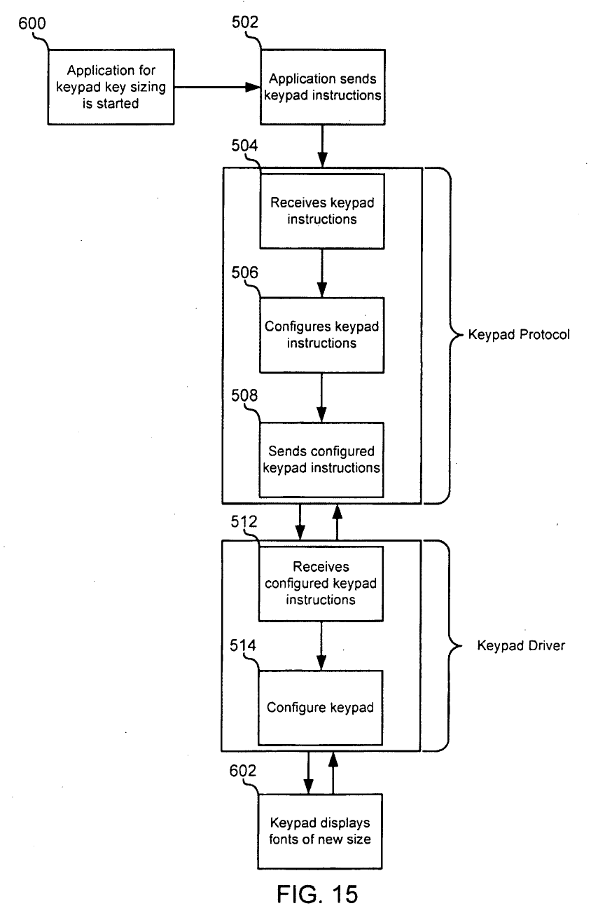

In another embodiment, the size of the numbers or letters that appear on a keypad 20 may be changed according to users' preferences or selections. In this embodiment, the mobile device is configured with software so users can change the color, size, font, format, language or orientation of the numbers, symbols or letters that appear on a keypad 20. For example, users with weak eye sight can enlarge the numbers that appear on the keypad 20 to facilitate their use of the mobile device. FIG. 15 illustrates example steps for changing the size of numbers displayed on a keypad 20. The process of changing the size of numerals displayed on the keypad may be implemented using an application 200. Once an application 200 for changing the size of numbers on the keypad 20 is stared, step 600, the application can present a menu to users to allow them to select a desired font size. Upon receiving the user input, the key sizing application 200 can send a keypad configuration instruction to the keypad protocol 206, step 502. This configuration instruction may include font size data or graphics files which the keypad protocol 206 can use to change the key display font. The keypad protocol 206 receives the keypad configuration instruction, processes the data and sends the instruction to the keypad driver 208 as described above with reference to FIG. 10 for steps 502-510. The keypad driver 208 receives the keypad configuration instruction and configures the keypad 20, as described above with reference to FIG. 10 for steps 512-514. The keypad 20 displays keypad labels in the new font size, step 602.

While this embodiment is described as being implemented by a font size-change application 200, the ability to set key font sizes may alternatively be included within the functionality of the keypad protocol 206. In this embodiment, the keypad protocol software includes a routine that may be activated by users which presents a menu or other suitable user interface for receiving instructions from users for setting the keypad display font size.

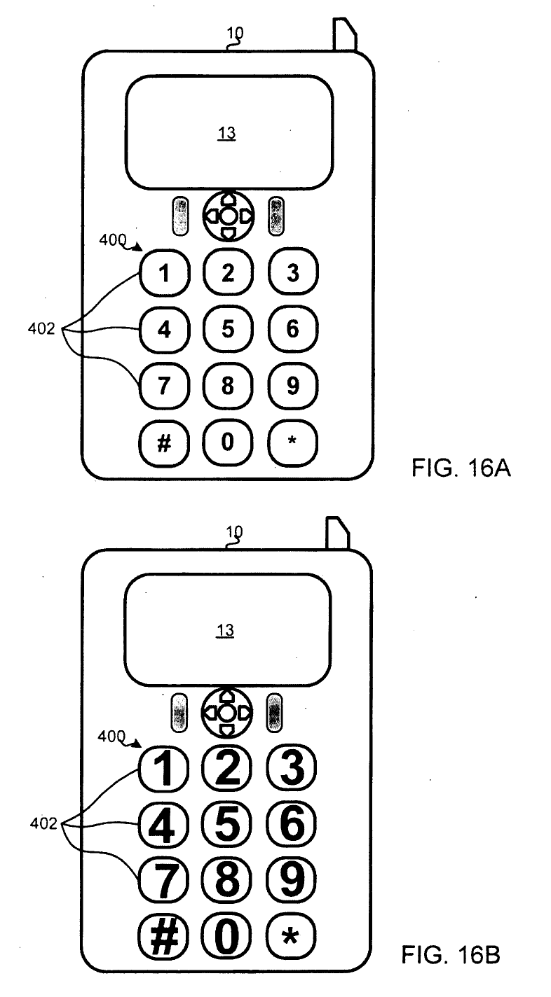

FIG. 16A illustrates a mobile device 10 equipped with display key-keypad 400 and display keys 402 configured to display the default size key display font. Users may select to enlarge the numbers that appear on the display keys 402, as shown in FIG. 16B. This selection to change the size of the numbers on the display keys 402 can be accomplished using the keypad protocol 206 as described above.

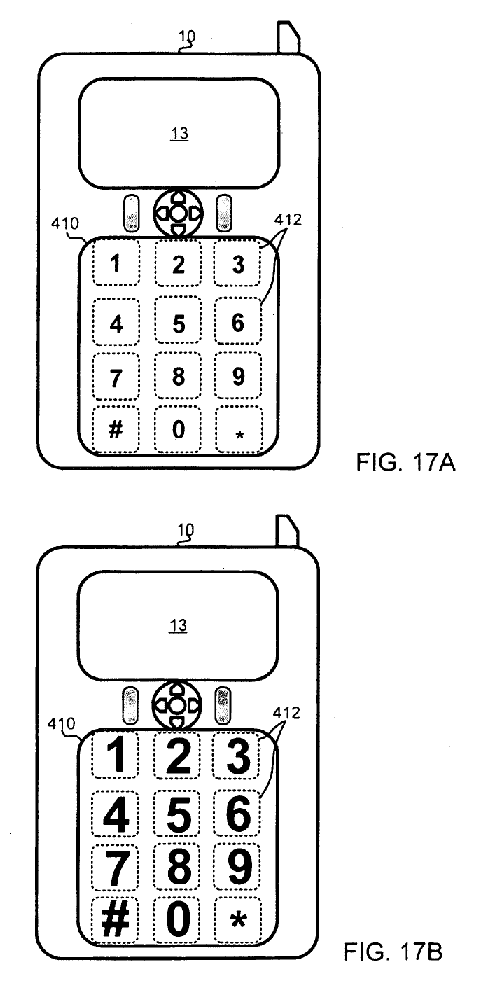

Similarly, FIG. 17A illustrates a mobile device 10 equipped with a touchscreen display user-interface 410 configured to display the default size key display font. As shown in FIG. 17B the virtual keys 412 can be configured to show enlarged numbers according to user selections.

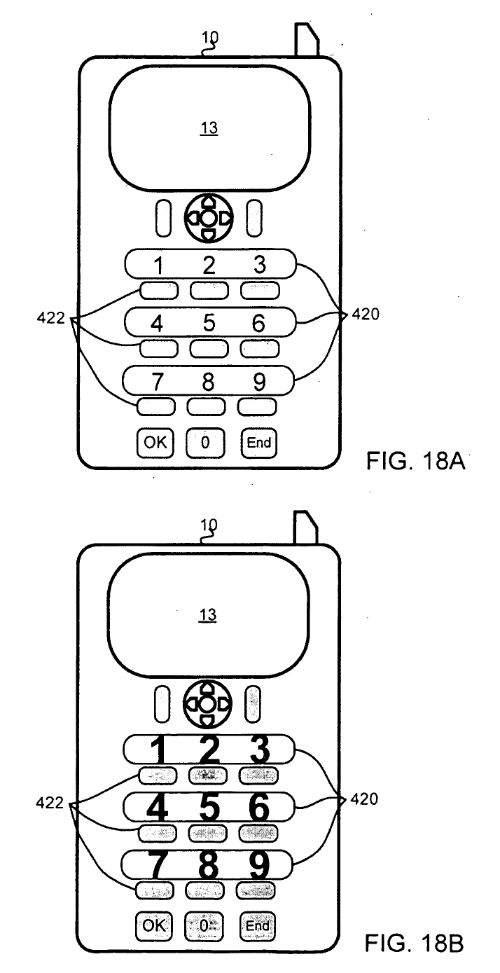

Similarly, FIG. 18A illustrates a mobile device equipped with keypad displays 420 positioned above keys 422 configured with the default key display font size. As shown in FIG. 18B, users can also configure the keypad displays 420 to show enlarged numbers according to user selections.

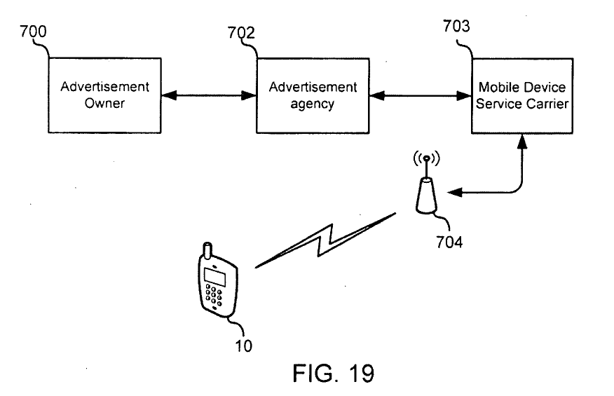

In another embodiment, the mobile device may be configured with software so the keypad 20 provides advertisement space on which companies may advertise their products or services to the users. Such advertising may be provided by the service provider for the mobile device, third parties, or selected and uploaded by the user. For example, the keypad 20 may be configured to designate a key that will either direct the user to an advertiser or show the advertisement contents on the mobile device display 13. FIG. 19 illustrates an embodiment network that advertisers may use to direct their advertisements to users' mobile devices 10. As shown, an advertisement owner 700 may contract with an advertisement agency 702. The advertisement agency 702 creates advertisement content and in turn may contract with a mobile device service carrier 703 to transmit the advertisement to the mobile device 10 for display on the designated keys of the keypad 20. Alternatively, an advertisement owner 700 may contract with a mobile device service carrier 703 directly. In a third alternative, the advertising agency 702 or advertisement owner 700 may transmit ads to the mobile device 10 using the cellular data network operated by the service carrier 703. The transmission of advertisements to the mobile device 10 may be accomplished using wireless or cellular data networks 704 or any other available modes of transmitting the advertisement data to a mobile device 10.

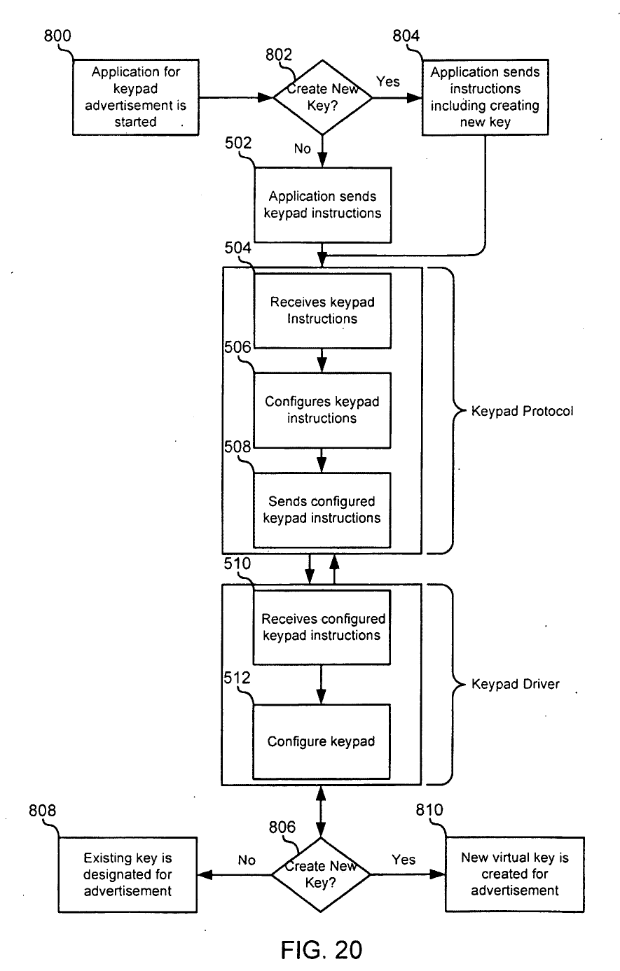

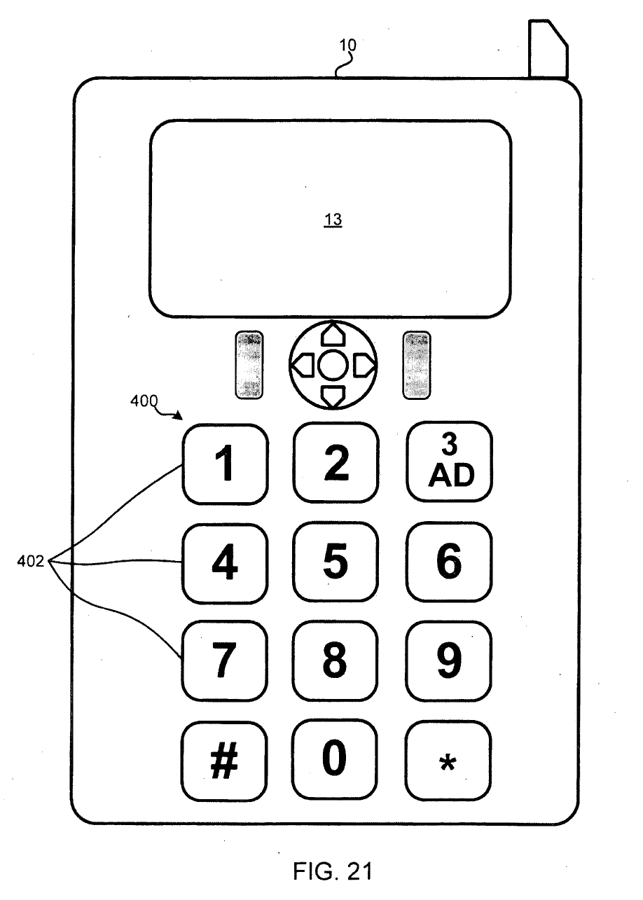

FIG. 20 illustrates example software steps that may be implemented to configure a keypad 20 to create or designate advertisement keys on a mobile device. The process of configuring a keypad to display and/or link to advertising may be implemented using an application 200. When an application 200 for advertisement is installed, step 800, the application may determine whether it can create a new key or designate an existing key as the advertisement key, step 802. Mobile devices with a fixed number of keys, such as display keypads 400 and keypads with associated displays as illustrated in FIG. 9, must designate an existing key for advertising, while a fully configurable touchscreen keypad can be reconfigured so that a new key can be created. If a new key is to be created, the application 200 reconfigures the layout of the touchscreen keypad and sends to the keypad protocol 206 a new keypad configuration instruction including graphic instructions that create a new key, step 804. If an existing key is to be used for advertising, the application 200 will send keypad configuration instructions to the keypad protocol 206 which include advertising related graphics and key-meaning instructions, step 502. The keypad configuration instructions is received by the keypad protocol 206 where it is processed and sent to the keypad driver 208 as described above with reference to FIG. 10 for steps 502-510. The keypad driver 208 receives the keypad configuration instruction and configures the keypad 20, as described above with reference to FIG. 10 for steps 512-514. The keypad configuration creates a new key, step 806, the keypad configuration creates a whole new keypad display including the newly create key, step 810. If the keypad has a fixed number of keys, step 806, is the keypad is configured with graphics or text display to designate one or more keys as advertisement key(s), step 808.

Using the various embodiments, a mobile device 10 equipped with a display keypad 400 can be configured to designate a key 402 as advertisement space with the key allocated a function (i.e., the function implemented when the key is pressed) that allows users to receive advertisement content or purchase the product or service associated with the advertisement. For example, the advertisement content may include information about advertiser's business, specials, sales or coupons. The mobile device service carrier may sell the advertisement space to generate revenue and to inform their users of available service, or may use the advertisement space to advertise its own services. The advertisement can be changed periodically as carriers and advertisers may prefer. In the example shown in FIG. 21, the mobile device may be configured with software so abbreviated advertisement content is linked to a particular key 402 designated as the advertisement key which in this example is the display key number “3.” Abbreviated advertisement information may be the word “AD” as shown in FIG. 21 for example, or another symbol, number, word or logo that can inform the users about the availability of an advertisement. Using a display keypad 400, the image presented on the ad key 402 may also be a graphic or picture. The mobile device may be configured with software so that upon pressing the key 402 designated for advertisement, the full advertisement content may be shown on the display 13. The keypad 20 may be configured to designate several keys 402 for advertisement. The display of advertisements and advertisement on one or more keys 402 may be provided at all times or only when the mobile device 10 is idle (i.e., is running an application requiring user input or engaged in a cellular telephone call).

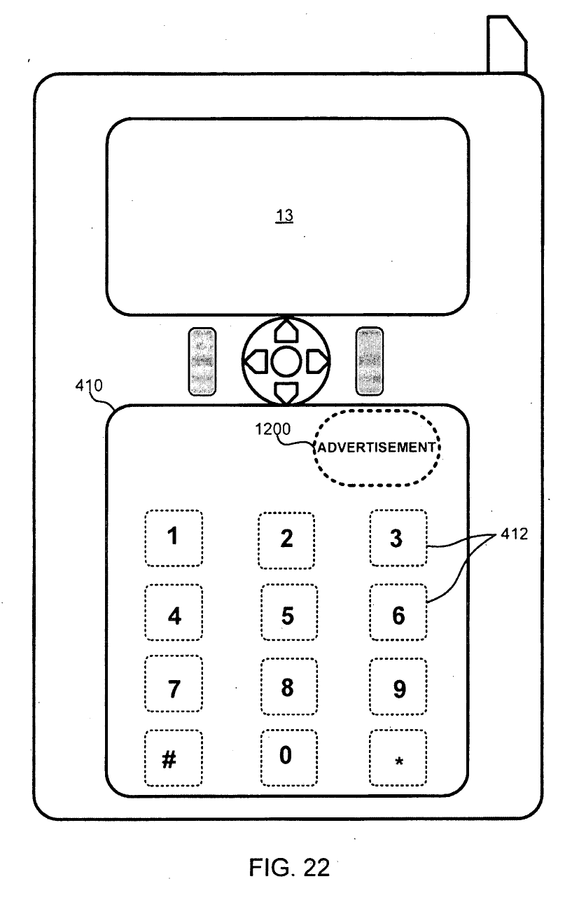

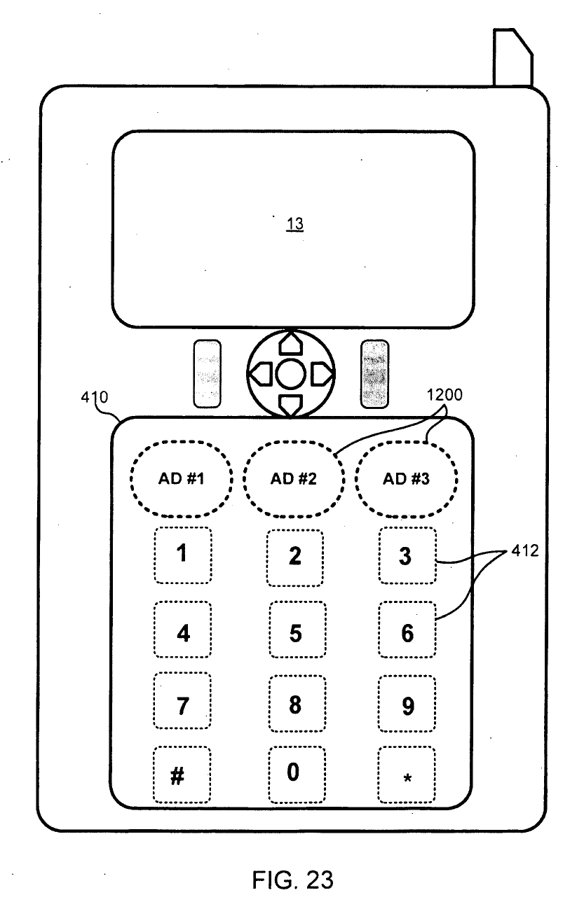

Similarly, as shown in FIG. 22, a mobile device 10 including a touchscreen 410 may be configured to include advertisement space on or relating to a virtual advertisement key 1200. Abbreviated advertisement content may appear on the advertisement key 1200. The mobile device may be configured with software so users may view the full advertisement content on the display 13 by pressing the virtual advertisement key 1200. In addition to showing abbreviated advertisement content, such as the logo or name of the advertiser, the mobile device may be configured so an advertisement key 1200 can show the full content of the advertisement. Alternatively, the mobile device may be configured to include more than one virtual advertisement key 1200, as shown in FIG. 23, to make available to the user more than one advertisement simultaneously. Each advertisement key 1200 may be associated with a different merchant. The display of advertisements and advertisement keys 1200 may be provided at all times or only when the mobile device 10 is idle (i.e., is running an application requiring user input or engaged in a cellular telephone call).

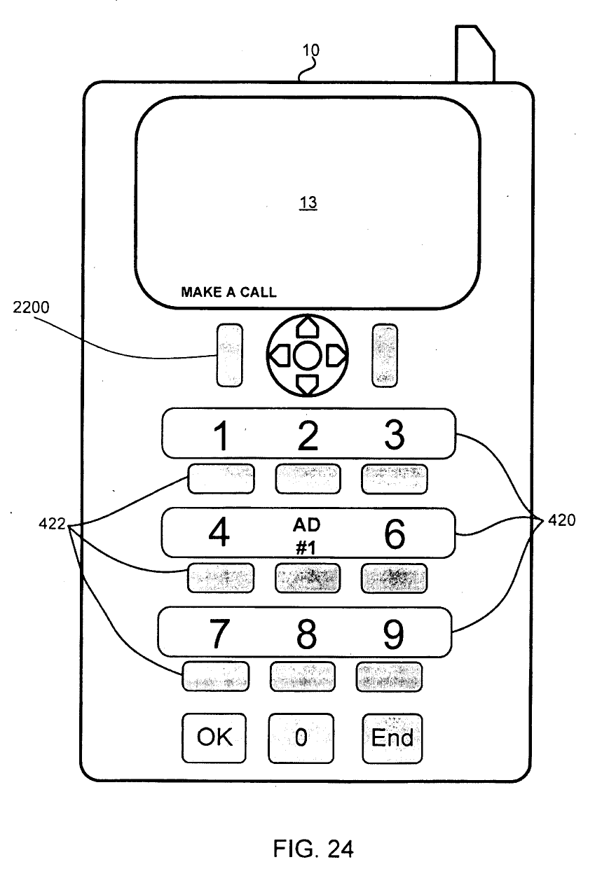

Similarly, as shown in FIG. 24, a mobile device 10 equipped with keypad displays 420 positioned above physical keys 422 can be configured with software to provide access to advertisements. In an embodiment, when the mobile device 10 is idle (i.e., is running an application requiring user input or engaged in a cellular telephone call), the mobile device 10 may be configured to switch to an advertisement mode in which the display 420 may automatically replace numbers (in this case number “5”) to show abbreviated advertisement content such as “AD #1.” The mobile device may be configured with software so users can view the full content of the advertisement by pressing the key 422 associated with the advertisement content. Also, the mobile device may be configured with software to provide an option in the display 13 to allow the user to exit the advertisement mode to use the mobile device 10 for other purposes, such as a cell phone. For example, the mobile device may be configured with software so users may select to use the mobile device 10 as a cell phone by pressing the button 2200 to “make a call.” In the illustrated example, the “make a call” function assigned to button 2200 is identified within the mobile device display 13. In response to a user pressing the button 2200 to “make a call,” the advertisement prompt, “AD #1,” is replaced by number “5” and the mobile device 10 is ready to be used as a cell phone. Alternatively, the mobile device may be configured with software so the user may exit the advertisement mode by pressing any key on the mobile device 10 other than the designated advertisement key.

In an embodiment, the mobile device may be configured with software so selected mechanical keys may be pre-designated for advertisement purposes. The pre-designated key may be part of the typical keypad or may be a separate new key designed exclusively for advertisement. The mobile device may be configured with software so advertisement content is shown on the display 13 when a user touches an advertisement key. In an embodiment, touch sensitive keypads which include touch sensors within keys may be used to enable users to view the advertisement content in the display by touching the key but without pressing which may be associated with purchasing the product or another function. A full disclosure of touch sensitive keypads having keys including touch sensors is provided in U.S. patent application Ser. No. ______ entitled “Methods and Systems for Revealing Function Assignments on Fixed Keypads,” which is filed concurrently herewith, the entire content of which are hereby incorporated by reference.

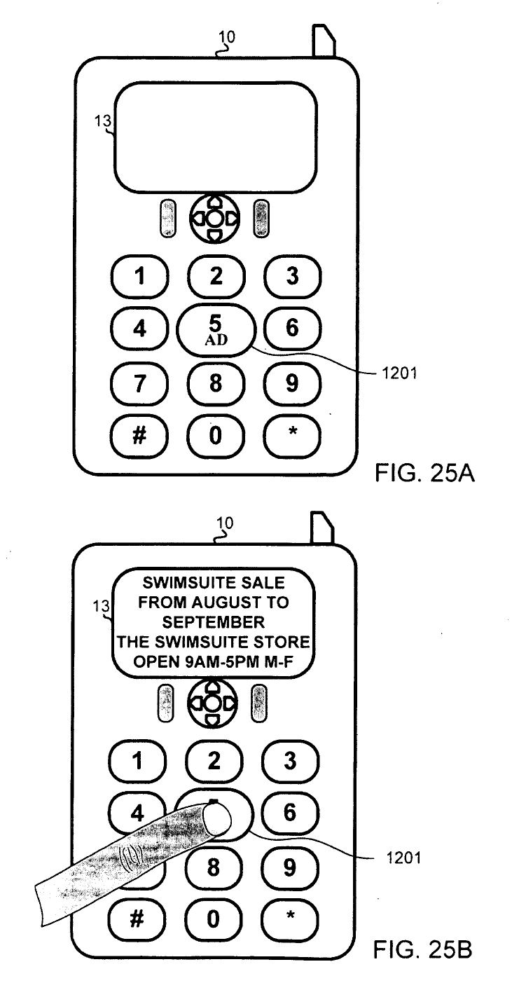

In an exemplary embodiment of a mobile device including a touch sensitive keypad that is configured with software to present advertisements on keys is illustrated in FIG. 25A. In this example, the mobile device may be configured with software so the number “5” key on the keypad is pre-designated as an advertisement key 1201 to which advertisement content may be associated. When a user touches but does not press that key, as shown in FIG. 25B, the full advertisement content associated with that key appears on the display 13. When the user presses the same advertisement key 1201, the mobile device may be configured with software so the processor recognizes the selection as number “5” and initiates phone functionality, and suspends presentation of the advertisement content until the phone call is terminated. Alternatively, the mobile device may be configured with software so that a press of the advertisement key 1201 activates a function related to the advertisement, such as placing a call to a phone number related to the advertisement or accessing the Internet and displaying a website associated with the advertisement.

In the various embodiments, the mobile device may be configured with software so users can manage the advertisement stream to their mobile devices 10. The mobile device may be configured with software so users can turn on and off the advertising capabilities of their mobile devices 10. Additionally, the mobile device may be configured with software so users can choose the types of advertisement they would like to receive. For example, users may choose to receive only coupons or only coupons related to certain items on certain days of the month. Such preferences may be set within the mobile device 10 or may be communicated to a server within the service provider which can serve as a filter for advertisements transmitted to the mobile device.

In an embodiment, the mobile device may be configured with software so users may configure their mobile devices 10 for speed-dialing using graphic displays to identify the contact associated with each speed-dial key. In conventional speed-dialing, users designate a key on the keypad 20 to represent a phone number (for example, the phone number of a friend or family member) that will be automatically dialed when the key is pressed. Speed-dialing keys allow the users to instantly call their designated contact by just pressing a key one time. Conventional speed-dialing functionality requires users to memorize the numbers assigned to their contacts or to consult a list of speed-dial assignments using a menu routine.

In an embodiment, key displays can be configured to display the name of the contact or an image (e.g., a picture) or graphic to remind users of the contact assigned to each speed-dial key. That allows the users to configure their mobile devices 10 to show their most contacted contacts on the keys of the keypad 20 without having to memorize the key assignments. This is helpful in many situations, such as during an emergency or while driving, where the users must pay attention to other more important matters.

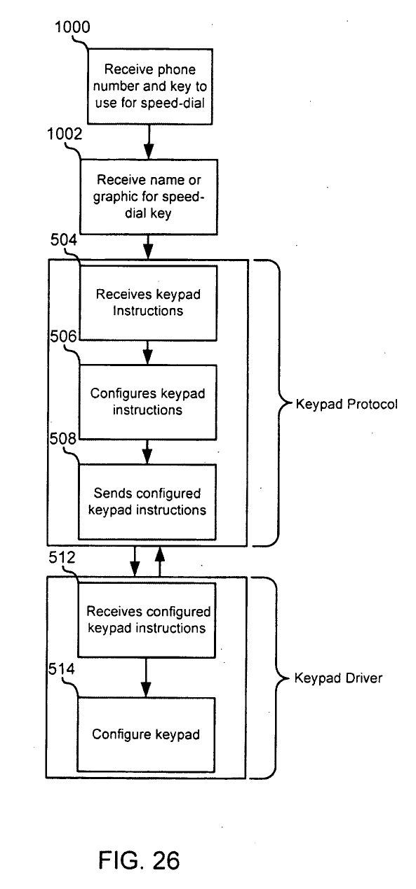

FIG. 26 illustrates example software steps that may be implemented to create customized speed-dialing keys on the keypad 20 according to an embodiment. This functionality may be implemented within system software as part of the Binary device functionality, in an application (e.g., a telephone application) or partially in system software and an application. A phone number and a key to be designated as a speed-dial key associated with the phone number are entered into and received by the mobile device, step 1000. This data entry may be made in response to menu prompts presented on the mobile device display 13 when an application to create speed-dial key assignments is initiated. As part of assigning the speed-dial key the user may be prompted to enter or identify (e.g., pointing to a graphic file stored in memory) a name, image or graphic to be associated with the speed-dial key, step 1002. Again, this information may be requested by and entered in response to menu prompts presented on the mobile device display 13. If an application is used to assign the speed-dial key, the application 200 uses the phone number, key number and associated name, graphic or image to format and send a keypad configuration instruction to the keypad protocol 206, step 502. Alternatively, the speed-dial key assignment functionality may be incorporated within the keypad protocol 206 or other system software. In either case the phone number, key number and associated name, graphic or image are accessed by the keypad protocol 206, step 504, and used generate keypad configuration commands, step 506. The keypad configuration commands are sent to the keypad driver 208, step 508, which receives the commands, step 512, and in turn configures the keypad, step 514. In configuring the keypad, the keypad driver 208 displays causes the name, graphic or image to be displayed by the keypad. In the case of display keypads 400, the name, graphic or image is presented on the key display of the designated speed-dial key. In the case of touchscreen keypads, the name, graphic or image may be presented within the virtual key or a new key may be displayed on the keypad including the name, graphic or image. In the case of keypads with displays above or below physical keys, the name, graphic or image can be presented in the portion of the display associated with the assigned speed-dial key. After the speed-dial key has been configured, the press of the key will generate a key event which can be interpreted by the keypad protocol 206 as corresponding with the speed-dial number rather than the normal function (e.g., number or letter) associated with the key, and this value routed to a telephone dialing function or application. Alternatively, the keypad protocol 206 may inform a telephone application 200 of a key event corresponding to the designated speed-dial. Given the flexibility in programming enabled by the keypad protocol 206, a variety of instruction formats and functional responsibility allocations may be used to implement speed-dialing with name, graphic or image information associated with the assigned key.

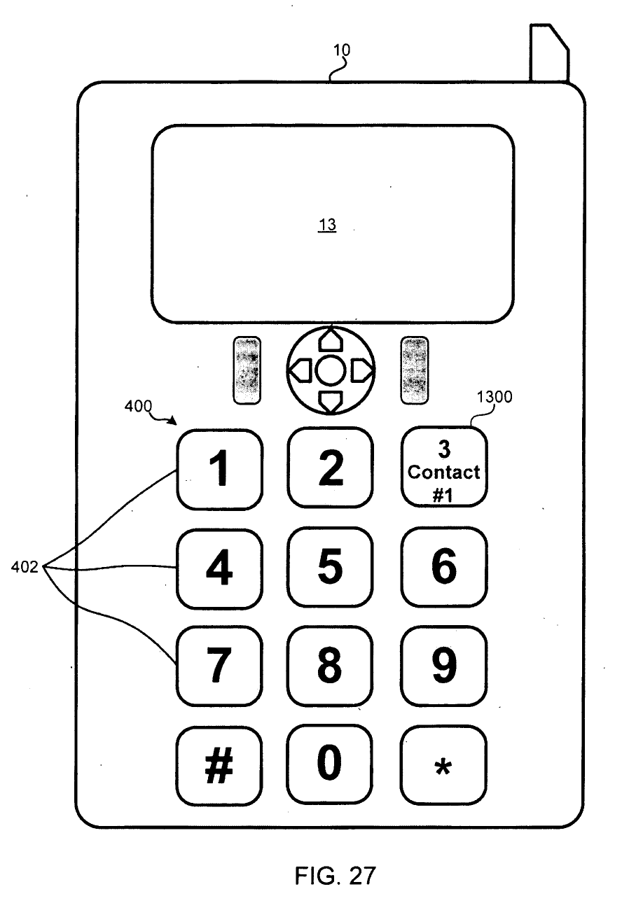

An example of this embodiment is illustrated in FIG. 27 which shows a mobile device 10 equipped with a display key-keypad 400 including display keys 402. In this example, the “3” key has been designated as a speed-dialing key 1300. The name of the contact (“Contact #1” for illustration purposes) is displayed on the speed-dial key 1300 so a user can see speed-dial assignment just by glancing at the key. So configured, pressing the “3” key will cause the mobile device 10 to dial the phone number of the designated contact, in this case “Contact #1,” without having to input every digit of the contact's phone number manually.

It should be noted that the use of speed-dial keys may also be applied to other immediate communications such as sending a page, an electronic mail or Short Message Service (SMS). In such applications, the address (e.g., phone number or e-mail address) stored in the speed-dial assignment is used to immediately address the communication.

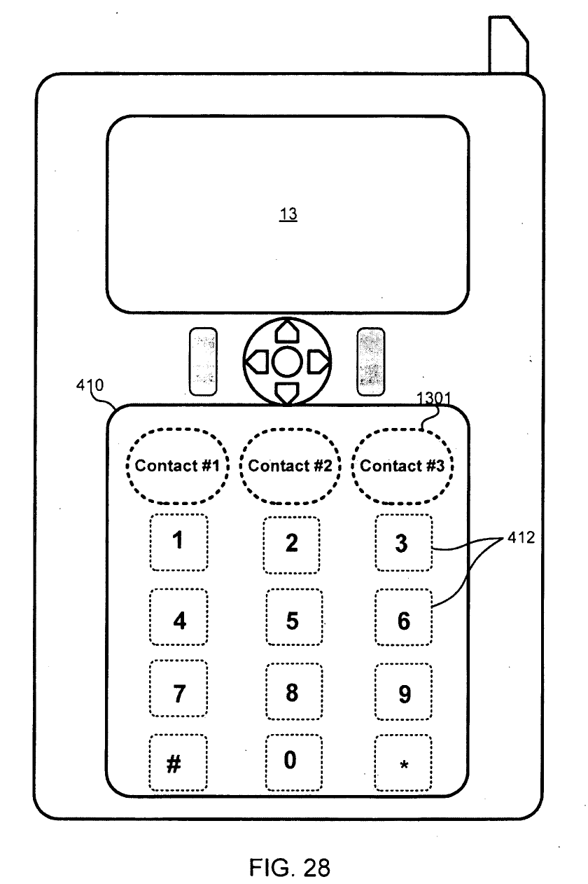

FIG. 28 shows an example of this embodiment implemented on a mobile device 10 with a touchscreen keypad 410 presenting virtual keys 412. In this example, three virtual speed-dialing keys 1301 are presented on the touchscreen keypad 410 including a name (for illustration purposes the names are “Contact #1,” “Contact #2” and “Contact #3” but in use would be a name, graphic or image associated with the speed-dial number). The speed-dialing keys 1301 may comprise or include a name, graphic and/or image associated with the speed-dial number, like a persons name and/or photograph, a graphic (e.g., a graphic of a police car for a “911” speed-dial), the number assigned to the virtual speed-dial key (e.g., “911” or “411”) or even just a color. While FIG. 28 shows the virtual speed-dial keys 1301 positioned above a keypad, the virtual speed-dial name, graphic or image may be positioned anywhere on the display and may be included with other application displays (e.g., a game or MP3 application).

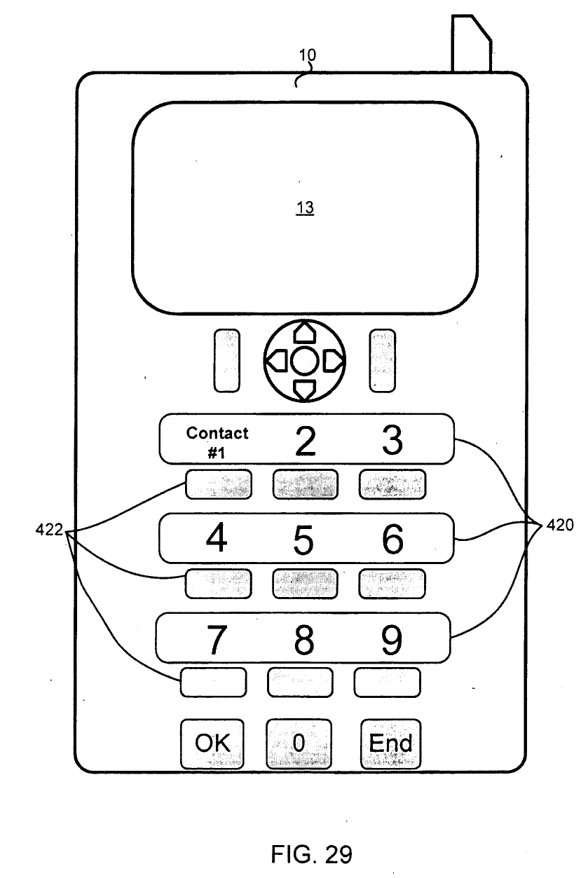

Similarly, FIG. 29 shows an example of this embodiment implemented on mobile devices 10 equipped with keypad displays 420 positioned above keys 422. In this example, the name, graphic or image associated with the speed-dial key can appear in the keypad display 420 above the assigned speed-dial key 422. In this example, the name “Contact #1” is displayed for the key, replacing the number “1” that otherwise would be presented.

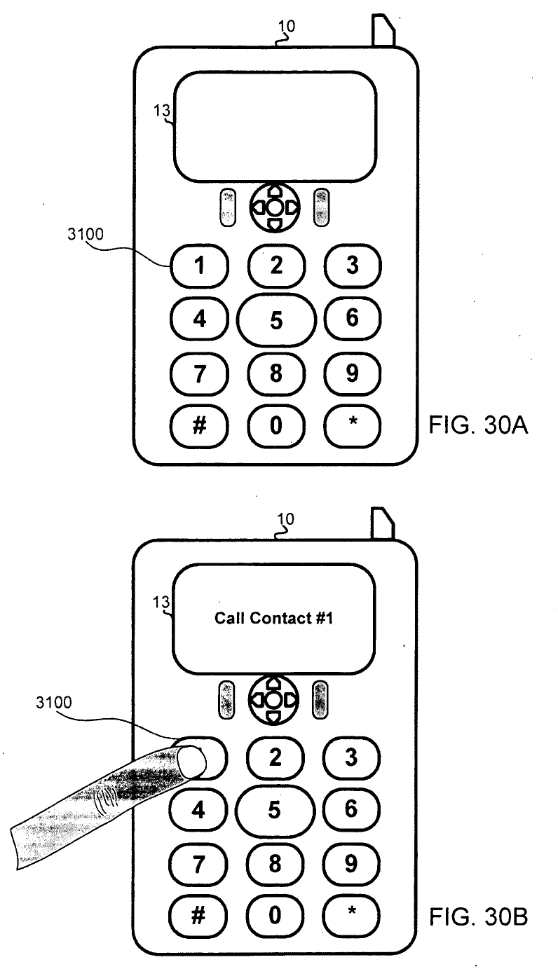

This embodiment may also be implemented in touch-sensitive keypads so that the speed-dial assignment information is presented on the mobile device display 13 when the assigned key is touched but not pressed. This embodiment is illustrated in FIGS. 30A and 30B which show a mobile device 10 having a touch sensitive keypad with a designated speed-dialing key 3100. As shown in FIG. 30B, mobile device including a touch sensitive keypad that is configured with software so that when the configured speed-dialing key 3100 is touched, the name, graphic or image associated with the speed-dial key is presented on the display 13. Thus, by touching keys, users are promptly reminded of the contact assigned to the touched key. Then, by pressing the desired speed-dialing key 3100 the mobile device 10 can automatically dial (or send a page, e-mail or SMS message) to the phone number associated with the speed-dial key.

The various embodiments may be implemented by the processor 11 executing software instructions configured to implement one or more of the described methods. Such software instructions may be stored in memory 12 as the device's operating system software, a series of APIs implemented by the operating system, or as compiled software implementing an embodiment method. Further, the software instructions may be stored on any form of tangible processor-readable memory, including: a random access memory 12, a memory module plugged into the mobile device 10, such as an SD memory chip, an external memory chip such as a USB-connectable external memory (e.g., a “flash drive”), read only memory (such as an EEPROM); hard disc memory, a floppy disc, and/or a compact disc.

Those of skill in the art would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in processor readable memory which may be any of RAM memory, flash memory, ROM memory, EPROM memory, EEPROM memory, registers, hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor. The processor and the storage medium may reside in an ASIC. The ASIC may reside in a user terminal or mobile device. In the alternative, the processor and the storage medium may reside as discrete components in a user terminal or mobile device. Additionally, in some aspects, the steps and/or actions of a method or algorithm may reside as one or any combination or set of codes and/or instructions on a machine readable medium and/or computer readable medium, which may be incorporated into a computer program product.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

What is claimed is:

1. A method for configuring a keypad of on a computing device comprising:
receiving a keypad configuration instruction in a keypad protocol, the keypad configuration instruction including information for display on the keypad; and
configuring the keypad in accordance with the keypad configuration instruction to display the information.

2. The method of claim 1, wherein the keypad configuration instruction is received in the keypad protocol from an application running on the computing device.

3. The method of claim 1, wherein the keypad configuration instruction is received in the keypad protocol in the form of user instructions received via the keypad on the computing device.

4. The method of claim 1, wherein the keypad is configured in accordance with the configuration instruction to display a theme on the keypad.

5. The method of claim 4, wherein the theme is animated.

6. The method of claim 4, wherein the theme is displayed on one or more keys of the keypad.

7. The method of claim 4, wherein the theme is displayed as a background to a touchscreen keypad.

8. The method of claim 1, wherein the keypad configuration instruction received in the keypad protocol is for changing the font size of letters or numbers displayed on the keypad, and the keypad is configured in accordance with the configuration instruction to display letters or numbers in a different font size.

9. The method of claim 8, wherein the keypad is configured in accordance with the configuration instruction to display letters or numbers in an enlarged font size.

10. The method of claim 1, wherein the keypad configuration instruction received in the keypad protocol includes advertisement information, and the keypad is configured in accordance with the configuration instruction to display at least a portion of the advertisement information.

11. The method of claim 10, further comprising:
receiving advertisement content in the computing device;
assigning the advertisement content to a key on the keypad; and
displaying the advertisement content when the assigned key is pressed.

12. The method of claim 6, wherein the keypad is configured in accordance with the configuration instruction to display a new virtual key on a touchscreen display, the new virtual key including at least a portion of the advertisement information.

13. The method of claim 1, wherein:
the keypad configuration instruction configures an assigned key on the keypad to perform a speed-dialing function for a telephone number;
the information included in the configuration instruction includes a name, graphic or image associated with the assigned speed-dial telephone number; and
the keypad is configured in accordance with the configuration instruction to display the name, graphic or image on or near the assigned speed-dial key.

14. The method of claim 13, wherein the keypad is configured in accordance with the configuration instruction to display a new virtual key on a touchscreen display, the new virtual key including the name, graphic or image associated with the assigned speed-dial key.

15. A computing device comprising:
a processor;
a display coupled to the processor;
a keypad coupled to the processor; and
a memory coupled to the processor,
wherein the processor is configured with software instructions to perform steps comprising:
receiving a keypad configuration instruction in a keypad protocol, the keypad configuration instruction including information for display on the keypad; and
configuring the keypad in accordance with the keypad configuration instruction to display the information.

16. The computer device of claim 15, wherein the processor is configured with software instructions to perform steps further comprising receiving the keypad configuration instruction from an application running on the computing device.

17. The computer device of claim 15, wherein the processor is configured with software instructions to perform steps further comprising receiving the keypad configuration instruction in the form of user instructions received via the keypad on the computing device.

18. The computer device of claim 15, wherein the processor is configured with software instructions to perform steps further comprising configuring the keypad in accordance with the configuration instruction to display a theme on the keypad.

19. The computer device of claim 15, wherein the processor is configured with software instructions to perform steps further comprising configuring the keypad in accordance with the configuration instruction to display an animated theme on the keypad.

20. The computer device of claim 15, wherein the processor is configured with software instructions to perform steps further comprising configuring the keypad in accordance with the configuration instruction to display a theme on one or more keys of the keypad

21. The computer device of claim 15, wherein
the keypad is a touchscreen keypad; and
the processor is configured with software instructions to perform steps further comprising configuring the touchscreen keypad in accordance with the configuration instruction to display a theme as a background to the keypad.

22. The computer device of claim 15, wherein the processor is configured with software instructions to perform steps further comprising configuring the keypad in accordance with the keypad configuration instruction to change the font size of letters and numbers displayed on the keypad.

23. The computer device of claim 22, wherein the font size is enlarged.

24. The computer device of claim 15, wherein the processor is configured with software instructions to perform steps further comprising configuring the keypad in accordance with the keypad configuration instruction to configure a key on the keypad to display advertisement information.

25. The computer device of claim 24, wherein the processor is configured with software instructions to perform steps further comprising:
receiving advertisement content in the computing device;
assigning the advertisement content to a key on the keypad; and
displaying the advertisement content when the assigned key is pressed.

26. The computer device of claim 25, wherein:
the keypad is a touchscreen keypad; and
the processor is configured with software instructions to perform steps further comprising configuring the touchscreen keypad in accordance with the configuration instruction to display at least a portion of the advertisement content within a new virtual key.

27. The computer device of claim 15, wherein the processor is configured with software instructions to perform steps further comprising configuring a key on the keypad to perform a speed-dialing function for a particular telephone number, and display a name, graphic or image associated with the speed-dialing telephone number on or near the assigned speed-dial key.

28. The computer device of claim 27, wherein:
the keypad is a touchscreen keypad; and
the processor is configured with software instructions to perform steps further comprising configuring the touchscreen keypad in accordance with the configuration instruction to display a new virtual key on the touchscreen display, the new virtual key including the name, graphic or image associated with the assigned speed-dial key.

29. The computer device of claim 15, wherein the keypad is a display-key keypad.

30. The computer device of claim 15, wherein the keypad is a touchscreen keypad.

31. The computer device of claim 15, wherein the keypad includes key displays positions above keys.

32. The computer device of claim 15, wherein the computing device is a mobile device.

33. The computer device of claim 15, wherein the computing device is a cellular telephone.

34. A tangible storage medium having stored thereon processor-executable software instructions configured to cause a processor of a computing device to perform steps comprising:
receiving a keypad configuration instruction in a keypad protocol, the keypad configuration instruction including information for display on a keypad; and
configuring a keypad on the computing device in accordance with the keypad configuration instruction to display the information.

35. The tangible storage medium of claim 34, wherein the tangible storage medium has stored thereon processor-executable software instructions configured to cause a processor of a computing device to perform further steps comprising receiving the keypad configuration instruction from an application running on the computing device.

36. The tangible storage medium of claim 34, wherein the tangible storage medium has stored thereon processor-executable software instructions configured to cause a processor of a computing device to perform further steps comprising receiving the keypad configuration instruction in the form of user instructions received via the keypad.

37. The tangible storage medium of claim 34, wherein the tangible storage medium has stored thereon processor-executable software instructions configured to cause a processor of a computing device to perform further steps comprising configuring the keypad in accordance with the configuration instruction to display a theme on the keypad.

38. The tangible storage medium of claim 34, wherein the tangible storage medium has stored thereon processor-executable software instructions configured to cause a processor of a computing device to perform further steps comprising configuring the keypad in accordance with the configuration instruction to display animated theme on the keypad

39. The tangible storage medium of claim 34, wherein the tangible storage medium has stored thereon processor-executable software instructions configured to cause a processor of a computing device to perform further steps comprising configuring the keypad in accordance with the configuration instruction to display a theme on one or more keys of the keypad.

40. The tangible storage medium of claim 34, wherein the tangible storage medium has stored thereon processor-executable software instructions configured to cause a processor of a computing device to perform further steps comprising configuring a touchscreen keypad in accordance with the configuration instruction to display a theme as a background to the touchscreen keypad.

41. The tangible storage medium of claim 34, wherein the tangible storage medium has stored thereon processor-executable software instructions configured to cause a processor of a computing device to perform further steps comprising configuring the keypad in accordance with the keypad configuration instruction to change the font size of letters and numbers displayed on the keypad.

42. The tangible storage medium of claim 41, wherein the font size is enlarged.

43. The tangible storage medium of claim 34, wherein the tangible storage medium has stored thereon processor-executable software instructions configured to cause a processor of a computing device to perform further steps comprising configuring the keypad in accordance with the keypad configuration instruction to configure a key on the keypad to display advertisement information.

44. The tangible storage medium of claim 34, wherein the tangible storage medium has stored thereon processor-executable software instructions configured to cause a processor of a computing device to perform steps further comprising:
receiving advertisement content in the computing device;
assigning the advertisement content to a key on the keypad; and
displaying the advertisement content when the assigned key is pressed.

45. The tangible storage medium of claim 44, wherein the tangible storage medium has stored thereon processor-executable software instructions configured to cause a processor of a computing device to perform further steps comprising configuring a touchscreen keypad in accordance with the configuration instruction to display at least a portion of the advertisement content within new virtual key.

46. The tangible storage medium of claim 34, wherein the tangible storage medium has stored thereon processor-executable software instructions configured to cause a processor of a computing device to perform further steps comprising configuring a key on the keypad to perform a speed-dialing function for a particular telephone number, and display a name, graphic or image associated with the speed-dialing telephone number on or near the assigned speed-dial key.

47. The tangible storage medium of claim 46, wherein the tangible storage medium has stored thereon processor-executable software instructions configured to cause a processor of a computing device to perform further steps comprising configuring the touchscreen keypad in accordance with the configuration instruction to display a new virtual key on the touchscreen display, the new virtual key including the name, graphic or image associated with the assigned speed-dial key.

48. A computing device, comprising
means for receiving a keypad configuration instruction in a keypad protocol, the keypad configuration instruction including information for display on the keypad; and
means for configuring the keypad in accordance with the keypad configuration instruction to display the information.

49. The computing device of claim 48, further comprising means for receiving the keypad configuration instruction from an application running on the computing device.

50. The computing device of claim 48, further comprising means for receiving the keypad configuration instruction from a keypad on the computing device.

51. The computing device of claim 48, wherein means for configuring the keypad in accordance with the keypad configuration instruction comprises means for displaying a theme on the keypad.

52. The computing device of claim 51, means for configuring the keypad in accordance with the keypad configuration instruction comprises means further comprises means for animating the theme displayed on the keypad.

53. The computing device of claim 51, further comprising means for displaying a theme on one or more keys of the keypad.

54. The computing device of claim 52, means for configuring the keypad in accordance with the keypad configuration instruction comprises means further comprises means for displaying the theme as a background to a touchscreen keypad.

55. The computing device of claim 48, wherein means for configuring the keypad in accordance with the keypad configuration instruction comprises means for changing the font size of letters and numbers on the keypad.

56. The computing device of claim 55, wherein means for changing the font size of letters and numbers on the keypad comprises means for enlarging the font size.

57. The computer device of claim 48, means for displaying advertisement information on the keypad.

58. The computer device of claim 57, further comprising:
means for receiving advertisement content;
means for assigning the advertisement content to a key on the keypad; and
means for displaying the advertisement content when the assigned key is pressed.

59. The computer device of claim 58, further comprising means for displaying the advertisement information in key new virtual key on a touchscreen keypad.

60. The computer device of claim 48, further comprising means for configuring a key on the keypad to perform a speed-dialing function and displaying a name, graphic or image associated with the configured speed dialing key.

61. The computer device of claim 60, further comprising means for displaying the name, graphic or image on a new virtual key on a touchscreen keypad.

62. The computing device of claim 48, further comprising a display-key keypad.

63. The computing device of claim 55, further comprising a touchscreen keypad.

64. The computing device of claim 55, further comprising key displays positioned above keys.

65. The computing device of claim 55, wherein the computing device is a mobile device.

66. The computing device of claim 55, wherein the computing device is a cellular telephone.
